(19) United States
(12) Patent Application Publication
(10) Pub. No.: US 2020/0383511 A1
(43) Pub. Date: Dec. 10, 2020

(54) DESEEDING APPARATUS

(71) Applicants: SAYEDALIREZA MOOSAVI, Frankfurt (DE); POUYA MOLANA, Frankfurt (DE)

(72) Inventors: SAYEDALIREZA MOOSAVI, Frankfurt (DE); POUYA MOLANA, Frankfurt (DE)

(21) Appl. No.: 16/895,987

(22) Filed: Jun. 8, 2020

(51) Int. Cl. A47J 23/00

(52) U.S. Cl. CPC A47J 23/00

(57) ABSTRACT

Disclosed is a deseeding apparatus comprising a plurality of receptacles, each of which for receiving a seeded fruit therewithin, a plurality of vertical, elongate plungers, each of which axially movable between a default top and a bottom position, each plunger, as a result of the movement thereof from the top position to the bottom position, plunges through a fruit disposed within the receptacle thereof resulting in the fruit being deseeded at which point, the deseeded fruit clings onto the plunger as the plunger moves from the bottom position to the top position, a horizontal separator bar comprising a plurality of separator holes, each of which surrounding a plunger so that, as a plunger moves to the top position, the deseeded fruit clinging thereto is pushed against the separator plate resulting in the deseeded fruit being disengaged from the plunger, and a collect container for collecting the disengaged deseeded fruits.

### BACKGROUND

The present disclosure relates to deseeding apparatuses and more particular to such an apparatus designed for deseeding multiple cherries at once.

Products such as jams, marmalades, squashes, etc., made out of cherries, both sweet and sour, are very commonly consumed in households. As part of the manufacturing of these products, one of the foremost activities involved in processing cherries is to deseed them. This process is also referred to as cherry coring, cherry stoning or cherry pitting. A cherry has a touch exterior skin, which surrounds a somewhat softer flesh. At an approximate center of the cherry is the seed thereof, which is also commonly referred to as “pit”. Manually deseeding cherries is quite a time-consuming task, which approximately would take around an hour for deseeding one kilogram of cherries. On the other hand, deseeding cherries by employing deseeding machines although takes care of the aforementioned time-consumption issue, one of the problems with the deseeding machinery known in the art is none of them takes care of all activities viz., loading cherries, deseeding the cherries, separating the seeds and separating the deseeded cherries. There is a need in the art for a cherry deseeding apparatus that meets the need of performing all the aforementioned activities. Another object of the invention is also to provide such an apparatus, which is simple in construction and cheaper to manufacture.

### SUMMARY

The present invention comprises a deseeding apparatus for deseeding multiple cherries at once. The apparatus comprises a receptacle bar, a separator bar, and a cylinder bar, all three of which are vertically aligned and supported by a pair of columns. The apparatus further comprises a load container and a collect container. The receptacle bar comprises an elongate horizontal bar comprising a plurality of cone-shaped receptacles disposed thereon. Each receptacle comprises a central receptacle hole disposed at the bottom thereof. Each receptacle is adapted to receive a cherry therewith. The apparatus further comprises an elongate, horizontal cylinder bar with a plurality of vertical cylinders extending downwardly therefrom. Each cylinder is adapted to snugly and slidably receive an elongate, spring-loaded plunger therewithin. The plunger is configured to longitudinally slide between a default top position and a bottom position wherein, at the top and bottom positions, the plunger is retracted into and extended out of the cylinder respectively. Notably, the retraction of the plunger is caused by the spring action.

The separator bar comprises an elongate, rectangular bar with a plurality of equidistant, thorough, circular separator holes disposed thereon. Upon the assemblage of the cylinder bar, cylinders, separator bar and the receptacle bar, each plunger extends through a separator hole. The apparatus further comprises a pair of load and collect arms, which connect the load and collect containers respectively to the cylinder bar. Each arm comprises an elongate, flat, rectangular bar with the four corners thereof rounded off. As can be appreciated from the referred illustrations, one extremity of each arm is hingedly secured an extremity of the cylinder bar whereby the arm (in the absence of the container corresponding thereto) can swivel about the point of hinge. Each of the load and collect containers comprises a substantially rectangular container. While the load container has two open sides, the collect container has only one open side. More particularly, the load container has the top and a side thereof being open, while the collect container has a side thereof being open. Notably, the sides of the load and the collect containers that are open face the assemblage (of the three bars) wherein, the open side is disposed opposite to the assemblage. Further notably, the load and collect containers are upwardly inclined with the open sides being upward. An elongate connecting rod passing through the bottom extremity of each arm and the corresponding container secures the container to the arm. More particularly, the connecting rod proceeding from the arm and extends through the outward bottom edge of the corresponding container thereby securing the container to the arm.

The apparatus is operationally configured such that, as each plunger moves from the top to the bottom position, said plunger plunges through the cherry disposed within the corresponding receptacle. As the plunger plunges through the cherry, the cherry is deseeded as the seed is discharged through the corresponding receptacle hole. As the plunger moves upwards, the deseeded cherry clings onto the plunger. As the plunger moves to the top position through the separator hole, the cherry clinging thereonto is pushed against the separator bar causing the deseeded cherry to disengage from the plunger.

The apparatus is further operationally configured such that, as the plunger moves to the top position, the collect container, as enabled by the collect arm, angularly moves to a collect position where, the collect container is disposed between the separator and the receptacle bars. Once in the collect position, the collect container receives the deseeded cherry disengaged from the plunger. As the plungers, upon disengaging the deseeded cherry, move to bottom position, the collect container, again, as enabled by the collect arm, moves from the collect position to a non-collect position. The apparatus is further operationally configured such that, as the plunger, post deseeding, moves to the bottom position, the load container, as enabled by the load arm, is tilted to a load position where, the load container, containing seeded cherries, loads the receptacles with the seeded cherries. Upon loading, the load container is tilted back to a non-load position. This process is repeated until all cherries in the load container are deseeded and collected by the collect container.

Other features and advantages will become apparent from the following description of the preferred embodiments, taken in conjunction with the accompanying drawings.

### BRIEF DESCRIPTION OF THE DRAWINGS

Various embodiments of the disclosed system and method are described herein with reference to the accompanying drawings, which form a part of this disclosure, wherein:

FIG. 1, according to an embodiment of the present invention, is an illustration of a perspective view of the deseeding apparatus.

FIG. 2, according to an embodiment of the present invention, is an illustration of a perspective view of the deseeding apparatus devoid of the load container and the arm thereof.

FIG. 3, according to an embodiment of the present invention, is another illustration of a perspective view of the deseeding apparatus.

FIG. 4, according to an embodiment of the present invention, is an illustration of a perspective view of the assembly of the cylinder bar and the separator bar and the plurality of cylinders extending therebetween.

FIG. 5, according to an embodiment of the present invention, is an illustration of a perspective view of the plunger.

FIG. 6, according to an embodiment of the present invention, is an illustration of a perspective view of the receptacle bar.

FIG. 7, according to an embodiment of the present invention, is an illustration of a perspective view of the separator bar.

FIG. 8, according to an embodiment of the present invention, is an illustration of a perspective view of the shoe.

FIG. 9, according to an embodiment of the present invention, is an illustration of a perspective view of the load container.

FIG. 10, according to an embodiment of the present invention, is an illustration of a perspective view of the collect container.

The various aspects of the present disclosure mentioned above are described in further detail with reference to the aforementioned figures and the following detailed description of exemplary embodiments.

### FIGURES—REFERENCE NUMERALS

10—Deseeding Apparatus
12—Receptacle Bar
14—Separator Bar
16—Cylinder Bar
18—Column
20—Shoe
22—Load Container
24—Collect Container
26—Arm
28—Connecting Rod
30—Receptacle
32—Receptacle Hole
36—Column Hole
38—Separator Hole
42—Cylinder
44—Plunger
46—Shoe Base
48—Projection
50—Step

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

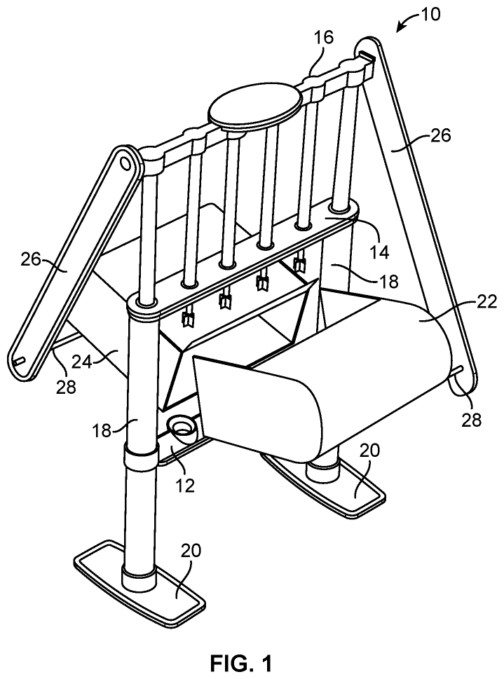

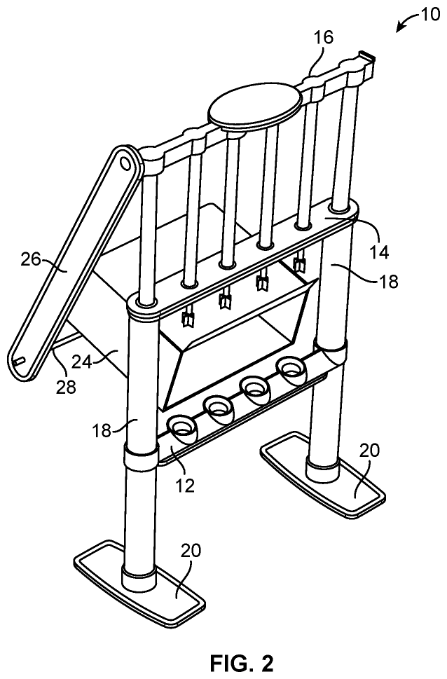

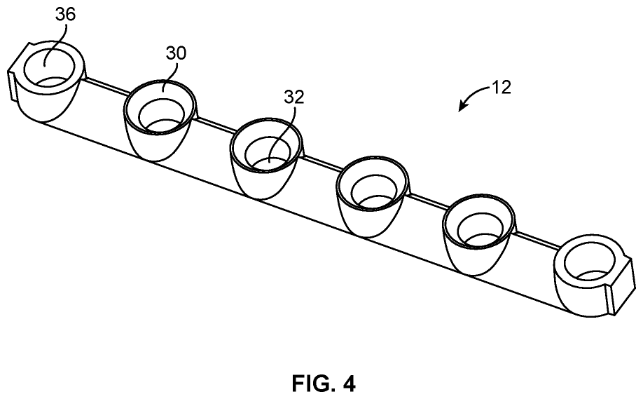

Embodiments of the present invention are directed to a deseeding apparatus for deseeding cherries, the process of which is also referred to in the art as cherry coring or cherry stoning. Referring to FIGS. 1 through 4, the apparatus 10 comprises a receptacle bar 12, a separator bar 14, and a cylinder bar 16, all three of which are supported by a pair of columns 18. The apparatus 10 further comprises a load container 22 and a collect container 24. The receptacle bar 12 comprises an elongate horizontal member of uniform inverted “V”-shaped cross-section. More particularly, the receptacle bar 12 comprises two downwardly sloped elongate, rectangular, flat bars joined together about the longitudinal edges thereof. The receptacle bar 12 further comprises a plurality of cone-shaped receptacles 30 disposed equidistantly thereon. Each receptacle 30 comprises a central receptacle hole 32 disposed at the bottom thereof. Each receptacle 30 is adapted to receive a cherry therewith for reasons that will become apparent from the following body of text. The receptacle bar 12 further comprises a pair of opposingly-disposed, thorough column holes 36, each of which disposed at an extremity thereof.

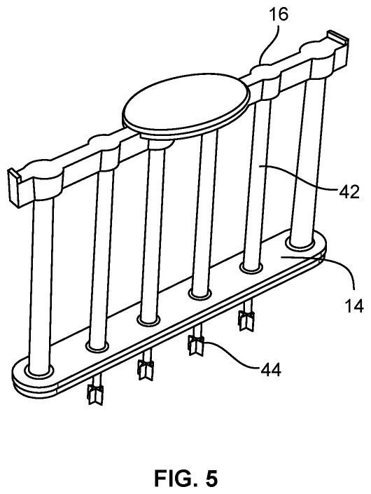

Referring to FIGS. 1 through 3, and 5, the apparatus 10 further comprises an elongate, horizontal cylinder bar 16 comprising a plurality of non-thorough, equidistant circular cylinder holes (not shown) disposed at the bottom thereof. As can be appreciated from the referred illustrations, a vertical cylinder 42 extends downwardly from each cylinder hole. Each cylinder 42 is adapted to snugly and slidably receive an elongate, spring-loaded plunger 44 therewithin. The plunger 44 is configured to longitudinally slide between a default top position and a bottom position wherein, at the top and bottom positions, the plunger 44 is, as constrained by the spring and the cylinder 42, retracted into and extended out of the cylinder 42 respectively. Notably, the retraction of the plunger 44 is caused by the spring action. The cylinder bar 16 further comprises a pair of opposingly-disposed, non-thorough circular column holes (not shown), each of which disposed at a bottom extremity thereof.

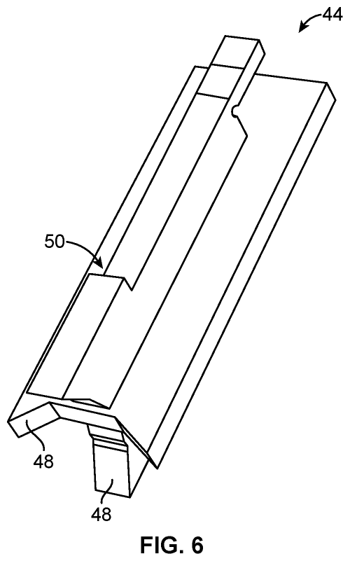

Referring to FIGS. 1 through 3, 5 and 6, the plunger 44 is of “+” shaped cross-section. More particularly, the plunger comprises four elongate, rectangular sections that, by coming together, form the aforementioned elongate “+” shaped structure. The bottom extremity surface of each rectangular section comprises three edges out of which, two opposingly-disposed edges comprise side edges while the remaining one edge is referred to as an extreme edge. Each extreme edge is projected beyond the surface of the bottom extremity surface and a steeply-sloped surface extends between the projected extreme edge and the extremity surface. The projection 48 renders the extreme edge sharper, the utility of which will become apparent from the following body of text. The outward longitudinal surface of each of any two opposingly-disposed rectangular sections comprises a stepped configuration 50. In one embodiment (not shown), the all four longitudinal surfaces include a stepped configuration 50.

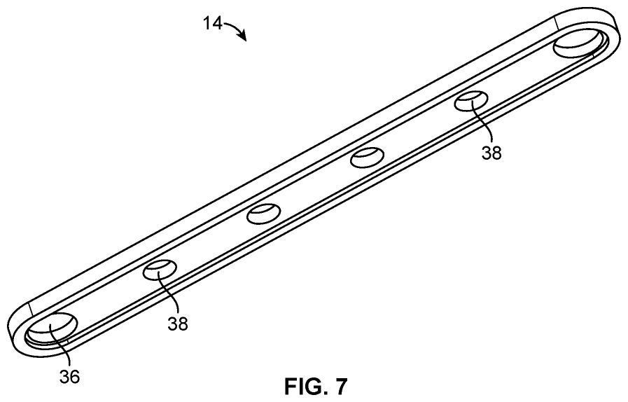

Referring to FIGS. 1 through 4, and 7, the separator bar 14 comprises an elongate, rectangular bar with the four corners thereof being rounded off. The top and bottom surfaces of the separator bar 14 are substantially planar and disposed opposite to one another. The separator bar 14 comprises a plurality of equidistant, circular separator holes 38 disposed thereon wherein, each separator hole 38 extends between the top and bottom planar surfaces. The separator bar 14 further comprises a pair of opposingly-disposed, thorough, circular column holes 36, each of which disposed at an extremity thereof. A pair of columns 18 extends through the pairs of column holes 36 pertaining to the receptacle bar 12 and the separator bar 14. The top extremities of the columns 18 are received within the column holes disposed on the cylinder bar 16.

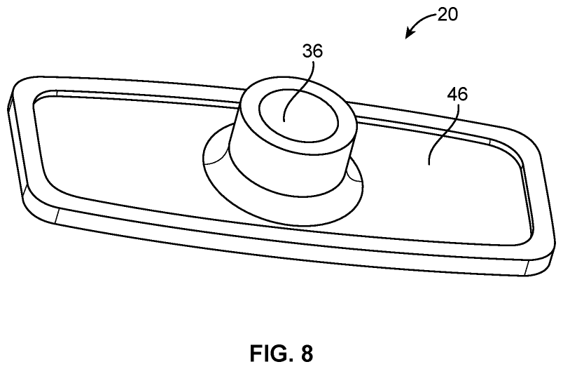

Referring to FIGS. 1 through 3 and 8, the apparatus 10 further comprises a pair of shoes 20, each of which comprising a shoe base 46 and a circular column hole 36. The shoe base 46 comprises a substantially rectangular member with the top and bottom surfaces thereof being substantially planar. The column hole 36 is disposed on the top surface of the shoe base 46 wherein, the column hole 36 is adapted to receive the bottom extremity of column 18 so as to enable the column 18 to stand vertically while supporting the cylinder 16, separator 14 and the receptacle 12 bars. Once the columns 18 are set up, it can be observed that the cylinders 42, separator holes 38, and the receptacles 30 are aligned with each other. Each plunger 44 extends through a separator hole 38 upon the assemblage of the columns 18, cylinder bar 16, cylinders 42, separator bar 14 and the receptacle bar 12. Notably, the cross-sectional diameter of the section of the column 18 extending between the cylinder and the separator bars 14 and 16 is lesser than that of the rest of the column 18, which extends between the separator bar 14 and the shoe 20. Hereinafter, for ease of reference, the assemblage of the columns 18, cylinder bar 16, cylinders 42, separator bar 14 and the receptacle bar 12 is referred to as the central assemblage.

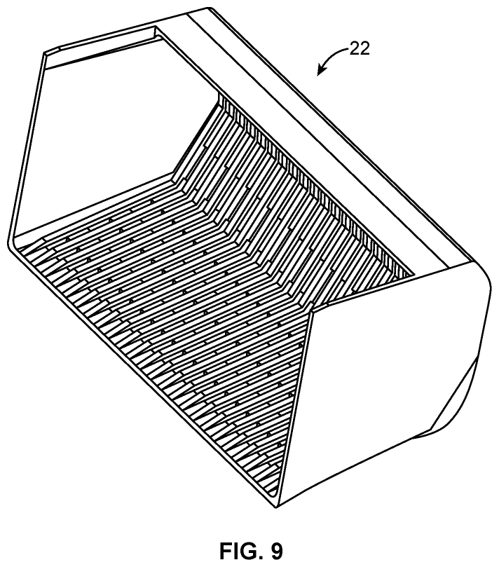

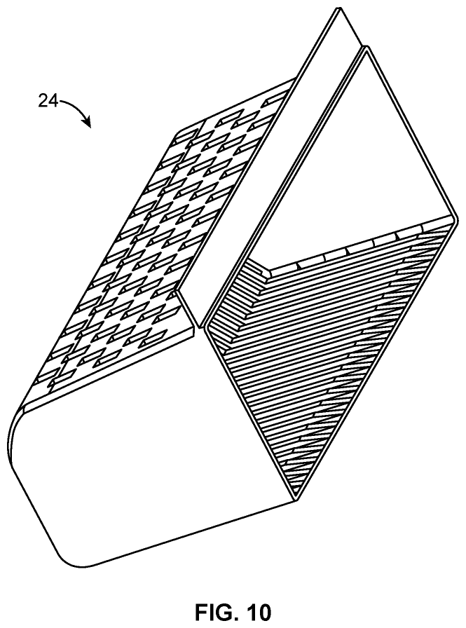

Referring to FIGS. 1 through 3, 5, 9 and 10, the apparatus 10 further comprises a pair of load and collect arms 26L and 26C, which connect the load and collect containers 22 and 24 respectively to the cylinder bar 16. Each arm 26 comprises an elongate, flat, rectangular bar with the four corners thereof rounded off. As can be appreciated from the referred illustrations, one extremity of each arm 26 is hingedly secured an extremity of the cylinder bar 16 whereby the arm 26 (in the absence of the container corresponding thereto) can swivel about the point of hinge. Each of the load and collect containers 22 and 24 comprises a substantially rectangular container. While the load container 22 has two open sides, the collect container 24 has only one open side. More particularly, the load container 22 has the top and a side thereof being open, while the collect container 24 has a side thereof being open. Notably, the sides of the load and the collect containers 22 and 24 that are open face the assemblage wherein, the open side is disposed opposite to the central assemblage. Further notably, the load and collect containers 22 and 24 are upwardly inclined with the open sides being upward. An elongate connecting rod 28 passing through the bottom extremity of each arm 26 and the corresponding container secures the container to the arm 26. More particularly, the connecting rod 28 proceeding from the arm 26 and extends through the outward bottom edge of the corresponding container thereby securing the container to the arm 26.

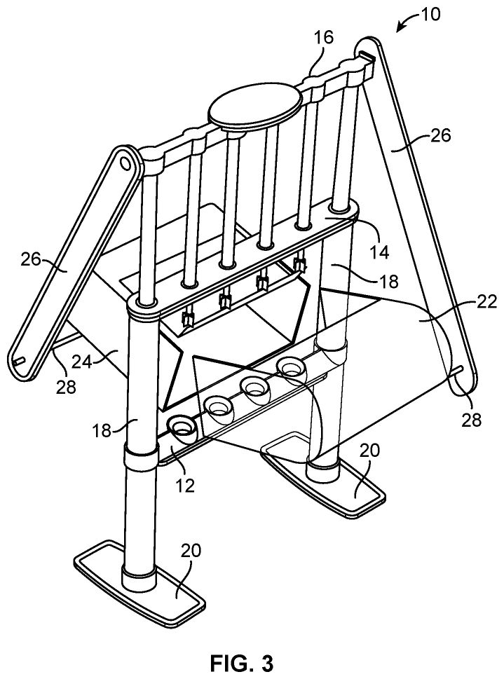

Referring to FIGS. 1 and 3, the apparatus 10 is operationally configured such that, as each plunger 44 moves from the top to the bottom position, said plunger 44 plunges through the cherry disposed within the corresponding receptacle 30. As the plunger 44 plunges through the cherry, the cherry is deseeded as the seed is discharged through the corresponding receptacle hole 32. Owing to the aforementioned stepped configuration 50 of the plunger 44, the deseeded cherry clings onto the plunger 44. As the plunger 44 moves to the top position through the separator hole 38, the cherry clinging thereonto is pushed against the separator bar 14 causing the deseeded cherry to disengage from the plunger 44.

Still referring to FIGS. 1 and 3, the apparatus 10 is further operationally configured such that, as the plunger 44 moves to the top position, the collect container 24, as enabled by the collect arm 26C, angularly moves to a collect position where, the collect container 24 is disposed between the separator and the receptacle bars 12 and 14. Once in the collect position, the collect container 24 receives the deseeded cherry disengaged from the plunger 44. As the plungers 44, upon disengaging the deseeded cherry, move to bottom position, the collect container 24, again, as enabled by the collect arm 26C, moves from the collect position to a non-collect position. The apparatus 10 is further operationally configured such that, as the plunger 44, post deseeding, moves to the bottom position, the load container 22, as enabled by the load arm 26L, is tilted to a load position where, the load container 24, containing seeded cherries, loads the receptacles 30 with the seeded cherries. Upon loading, the load container 22 is tilted back to a non-load position. This process is repeated until all cherries in the load container 22 are deseeded and collected by the collect container 24. Notably, the number of receptacles 30, separator holes 38, and plungers 44 can be increased further to increase the deseeding output. In one embodiment, the apparatus 10 is configured to be automated by having the movements of the plungers 44, load container 22, and/or the collect container 24 to be automated by employing an electric motor or the like.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A deseeding apparatus comprising:
(a) a plurality of receptacles, each of which for receiving a seeded fruit therewithin, each receptacle comprising a receptacle hole disposed at the bottom thereof;
(b) a plurality of vertical, elongate plungers, each of which axially movable between a default top and a bottom position, each plunger, as a result of the movement thereof from the top position to the bottom position, plunges through a fruit disposed within the receptacle thereof resulting in the fruit being deseeded at which point, the deseeded fruit clings onto the plunger as the plunger moves from the bottom position to the top position;
(c) a horizontal separator bar comprising a plurality of separator holes, each of which surrounding a plunger so that, as a plunger moves to the top position, the deseeded fruit clinging thereto is pushed against the separator plate resulting in the deseeded fruit being disengaged from the plunger; and
(d) a collect container disposed in operative communication with the plurality of plungers such that, as the collect container is angularly moved from a non-collect to a collect position, the plungers are moved from the bottom position to the top position; the collect container for collecting the deseeded fruits when disengaged from the plungers.

2. The apparatus of claim 1 wherein, the seeded fruit comprises a single-seeded fruit.

3. The apparatus of claim 2 wherein, the single-seeded fruit comprises a cherry.

4. The apparatus of claim 1 wherein, the seed is discharged through the receptacle hole as the corresponding fruit is deseeded.

5. The apparatus of claim 1 wherein, each plunger is spring-loaded as a result of which, the upward movement thereof to the top position is caused by the spring.

6. The apparatus of claim 1 wherein, each plunger is of a “+” shaped cross-section, the free bottom extremity the plunger comprising four extreme edges projected beyond the surface of the free extremity; each extreme edge connected to the surface of the free extremity by means of a sloped surface thereby enabling the plunger to penetrate through the fruit better.

7. The apparatus of claim 6 wherein, the plunger comprises four elongate, rectangular sections attached to one another so as to form a “+”-shaped cross-section; the outward longitudinal surface of at least two opposingly-disposed rectangular sections comprising a stepped down configuration, which enables a deseeded fruit to cling onto the plunger.

8. The apparatus of claim 1 further comprising a horizontal cylinder bar comprising a plurality of cylinders proceeding downwardly from the bottom of the cylinder bar; each cylinder for snugly and slidably receiving a plunger therewithin.

9. The apparatus of claim 8 wherein, the separator holes, receptacle holes and the cylinders are aligned with each other.

10. The apparatus of claim 8 further comprising a pair of columns for supporting the receptacle bar, separator bar, and the cylinder bar at the extremities of each thereof.

11. The apparatus of claim 10 further comprising a pair of shoes, each of which comprising a planar bottom surface and a column hole within which the bottom extremity of a column is received; the shoes for supporting the apparatus on floor.

12. The apparatus of claim 8 further comprising an elongate collect arm, a bottom extremity of which is connected to the collect container, the top extremity of the collect arm hingedly secured to one of the extremities of the cylinder bar so as to enable the angular movement of the collect container.

13. The apparatus of claim 8 further comprising an elongate load arm, a bottom extremity of which is connected to a load container, the top extremity of the load arm hingedly secured to one of the extremities of the cylinder bar so as to enable angular movement of the load container.

14. The apparatus of claim 13 wherein, the load container is angularly movable from a non-load to a load position as the plungers move from the top position to the bottom position, the load container containing seeded fruits for loading the receptacles when moved to the load position thereof.

15. The apparatus of claim 14 wherein, the angular movements of the load and collect containers are automated.

16. The apparatus of claim 14 wherein, the load container is of rectangular shape with two mutually perpendicular open sides viz., a top and a side.

17. The apparatus of claim 1 wherein, the collect container is of rectangular shape with one open side for receiving deseeded fruits.

18. The apparatus of claim 1 wherein, the interior contour of each receptacle is cone-shaped.

19. A deseeding apparatus comprising:
(a) a plurality of receptacles, each of which for receiving a single-seeded fruit therewithin, each receptacle comprising a receptacle hole disposed at the bottom thereof;
(b) a plurality of elongate, vertical, spring-loaded plungers, each of which vertically movable between a default top and a bottom position, each plunger, as a result of the movement thereof from the top to the bottom position, plunges through a fruit disposed within the receptacle thereof resulting in the fruit being deseeded at which point, the deseeded fruit clings onto the plunger as the plunger moves from the bottom to the top position;
(c) a horizontal separator plate comprising a plurality of separator holes, each of which surrounding a plunger so that, when a plunger moves to the top position, the deseeded fruit clinging thereto is pushed against the separator plate resulting in the deseeded fruit being disengaged from the plunger;
(d) a collect container disposed in operative communication with the plungers whereby, as the collect container is angularly moved from a non-collect to a collect position, the plungers are moved from the bottom to the top position, the collect container for collecting the deseeded fruits when disengaged from the corresponding plungers; and
(e) a load container angularly movable from a non-load to a load position as the plungers move from the top to the bottom position, the load container, which contains the seeded fruits, for loading the receptacles with the seeded fruits when moved to the load position.
